(19) United States
(12) Patent Application Publication
(10) Pub. No.: US 2022/0286004 A1
(43) Pub. Date: Sep. 8, 2022

(54) ROTOR, MOTOR, COMPRESSOR, AND AIR CONDITIONER

(71) Applicant: Mitsubishi Electric Corporation, Tokyo (JP)

(72) Inventors: Takanori WATANABE, Tokyo (JP); Atsushi MATSUOKA, Tokyo (JP)

(21) Appl. No.: 17/637,593

(22) PCT Filed: Oct. 11, 2019
(86) PCT No.: PCT/JP2019/040174

§ 371 Date: Feb. 23, 2022

(51) Int. Cl. H02K 1/276; H02K 21/14; F25B 31/02

(52) U.S. Cl. CPC H02K 1/2766; H02K 21/14; F25B 31/026; H02K 2213/03

(57) ABSTRACT

A rotor includes: a rotor core including first electromagnetic steel sheets and second electromagnetic steel sheets; and a permanent magnet. Each of the first electromagnetic steel sheets includes a first magnet insertion hole, a first thin portion, and a magnet locking portion that is in contact with an end portion of the permanent magnet. Each of the second electromagnetic steel sheets includes a second magnet insertion hole and a second thin portion. Each of the second electromagnetic steel sheets does not include a portion that is in contact with the end portion of the permanent magnet. W1>W2 is satisfied, where W1 is a minimum width of the first thin portion and W2 is a minimum width of the second thin portion.

### CROSS REFERENCE TO RELATED APPLICATION

This application is a U.S. national stage application of International Patent Application No. PCT/JP2019/040174 filed on Oct. 11, 2019, the disclosure of which is incorporated herein by reference.

### TECHNICAL FIELD

The present invention relates to a rotor of a motor.

### BACKGROUND

In a general motor such as an interior permanent magnet motor, a thin portion is provided between a magnet insertion hole of a rotor core and an outer peripheral surface of the rotor core (see, for example, Patent Reference 1). In a case where magnetic flux from the surface of a permanent magnet of a rotor enters an adjacent permanent magnet in a magnetic pole part through the thin portion interposed, output density of the motor decreases. That is, when magnetic flux leakage in the rotor increases, output density of the motor decreases. In view of this, a proposed rotor includes a rotor core having a small width of a thin portion in order to reduce magnetic flux leakage. Influence of magnetic flux leakage can be compensated for by increasing the amount of permanent magnets. As the amount of permanent magnets in each magnetic pole part of the rotor, output density of the motor increases.

### PATENT REFERENCE

Patent Reference 1: Japanese Patent Application Publication No. 2010-226830

As the amount of permanent magnets in the rotor increases, however, a centrifugal force generated in the rotor during rotation of the rotor increases. In particular, the centrifugal force generated in the rotor during rotation of the rotor tends to be concentrated in the thin portion. To maintain strength of the rotor, the width of the thin portion is preferably increased. However, as the width of the thin portion increases, magnetic flux leakage increases, and efficiency of the motor decreases.

### SUMMARY

It is therefore an object of the present invention to solve the problems described above and increase efficiency of a motor.

A rotor according to one aspect of the present invention includes: a rotor core including two or more first electromagnetic steel sheets and two or more second electromagnetic steel sheets that are stacked in an axis line direction; and at least one permanent magnet disposed in the rotor core, wherein each of the two or more first electromagnetic steel sheets includes a first magnet insertion hole in which the at least one permanent magnet is disposed, a first thin portion provided between an outer end portion of the first magnet insertion hole in a radial direction of the rotor core and an outer peripheral surface of the rotor core, and a magnet locking portion that is adjacent to the first thin portion and is in contact with an end of the at least one permanent magnet, the end of the at least one permanent magnet facing the outer peripheral surface of the rotor core, a center portion of the first magnet insertion hole is situated close to an axis line with respect to both end portions of the first magnet insertion hole in a circumferential direction in a plane perpendicular to the axis line, each of the two or more second electromagnetic steel sheets includes a second magnet insertion hole in which the at least one permanent magnet is disposed, the second magnet insertion hole communicating with the first magnet insertion hole, and a second thin portion provided between an outer end portion of the second magnet insertion hole in the radial direction and the outer peripheral surface of the rotor core, a center portion of the second magnet insertion hole is situated close to the axis line with respect to both end portions of the second magnet insertion hole in the circumferential direction in the plane, each of the two or more second electromagnetic steel sheets does not include a portion that is in contact with the end of the at least one permanent magnet, W1>W2 is satisfied, where W1 is a minimum width of the first thin portion in the plane and W2 is a minimum width of the second thin portion in the plane, and a length of the second thin portion in the circumferential direction is larger than a length of the first thin portion in the circumferential direction.

A motor according to another aspect of the present invention includes: a stator; and the rotor disposed inside the stator.

A compressor according to yet another aspect of the present invention includes: a compression device; and the motor configured to drive the compression device.

An air conditioner according to still another aspect of the present invention includes: the compressor; and a heat exchanger.

According to the present invention, efficiency of the motor can be enhanced.

### BRIEF DESCRIPTION OF THE DRAWINGS

FIG. 1 is a cross-sectional view schematically illustrating a structure of a motor according to a first embodiment of the present invention.

FIG. 2 is a cross-sectional view schematically illustrating a structure of a rotor.

FIG. 3 is an enlarged view illustrating a part of a first electromagnetic steel sheet.

FIG. 4 is an enlarged view illustrating another part of the first electromagnetic steel sheet.

FIG. 5 is a plan view schematically illustrating a structure of a second electromagnetic steel sheet.

FIG. 6 is an enlarged view illustrating a part of the second electromagnetic steel sheet.

FIG. 7 is an enlarged view illustrating another part of the second electromagnetic steel sheet.

FIG. 8 is a cross-sectional view taken along line C8-C8 in FIGS. 3 and 6.

FIG. 9 is a graph showing a relationship between a minimum width of a thin portion of an electromagnetic steel sheet in a radial direction and a maximum stress generated in the thin portion during rotation of the rotor.

FIG. 10 is a cross-sectional view illustrating another example of a rotor core.

FIG. 11 is a cross-sectional view illustrating yet another example of the rotor core.

FIG. 12 is a cross-sectional view illustrating still another example of the rotor core.

FIG. 13 is a cross-sectional view illustrating still another example of the rotor core.

FIG. 14 is a cross-sectional view illustrating still another example of the rotor core.

FIG. 15 is a cross-sectional view illustrating still another example of the rotor core.

FIG. 16 is a cross-sectional view illustrating still another example of the rotor core.

FIG. 17 is a diagram illustrating an example in which permanent magnets are shifted in an axis line direction.

FIG. 18 is a cross-sectional view illustrating still another example of the rotor core.

FIG. 19 is a cross-sectional view illustrating still another example of the rotor core.

FIG. 20 is a graph showing a magnetic force of the rotor and a magnitude of demagnetization resistance with reference to a comparative example.

FIG. 21 is a cross-sectional view schematically illustrating a structure of a compressor according to a second embodiment of the present invention.

FIG. 22 is a diagram schematically illustrating a configuration of a refrigeration air conditioning apparatus according to a third embodiment of the present invention.

### DETAILED DESCRIPTION

### First Embodiment

In an xyz orthogonal coordinate system shown in each drawing, a z-axis direction (z axis) represents a direction parallel to an axis line Ax of a motor 1, an x-axis direction (x axis) represents a direction perpendicular to the z-axis direction, and a y-axis direction (y axis) represents a direction perpendicular to both the z-axis direction and the x-axis direction. The axis line Ax is a rotation center of a rotor 2 and is also an axis line of the rotor 2. The direction parallel to the axis line Ax will also be referred to as an “axis direction of the rotor 2” or simply an “axis direction.” The “axis direction” may also be referred to as an “axis line direction.” The radial direction refers to a radial direction of the rotor 2, a rotor core 21, or a stator 3, and is a direction perpendicular to the axis line Ax. An xy plane is a plane perpendicular to the axial direction. An arrow A1 represents a circumferential direction about the axis line Ax. The circumferential direction of the rotor 2, the rotor core 21, or the stator 3 will also be referred to simply as a “circumferential direction.”

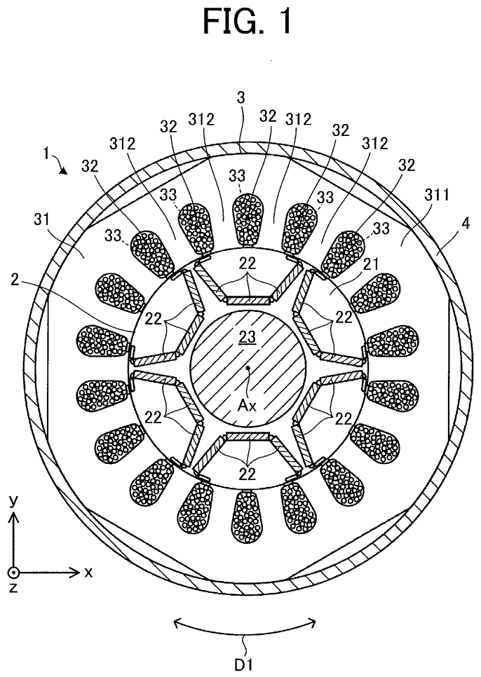

FIG. 1 is a cross-sectional view schematically illustrating a structure of the motor 1 according to a first embodiment.

The motor 1 includes the rotor 2, and the stator 3 disposed outside the rotor 2. As illustrated in FIG. 1, the motor 1 may further include a motor frame 4 covering the stator 3. The motor 1 is, for example, a permanent magnet synchronous motor (also referred to as a brushless DC motor) such as an interior permanent magnet motor. The motor 1 is used for, for example, a compressor such as a rotary compressor.

### <Stator 3>

The stator 3 will be specifically described.

As illustrated in FIG. 1, the stator 3 includes a stator core 31, at least one winding 32, and a plurality of slots 33 in which the at least one winding 32 is disposed.

The stator core 31 includes a yoke 311 having a ring shape, and a plurality of teeth 312. In this embodiment, the stator core 31 includes eighteen teeth 312 and eighteen slots 33. Each of the slots 33 is space between adjacent ones of the teeth 312.

The number of the teeth 312 is not limited to eighteen. Similarly, the number of the slots 33 is not limited to eighteen.

As illustrated in FIG. 1, the teeth 312 are arranged radially on the xy plane. In other words, the plurality of teeth 312 are arranged at regular intervals in the circumferential direction of the stator core 31. Each of the teeth 312 extends from the yoke 311 toward the rotation center of the rotor 2. In other words, each of the teeth 312 projects from the yoke 311 radially inward.

The plurality of teeth 312 and the plurality of slots 33 are alternately provided at regular intervals in the circumferential direction of the stator core 31.

The stator core 31 is an annular iron core. The stator core 31 includes a plurality of electromagnetic steel sheets stacked in the axis direction. These electromagnetic steel sheets are fixed together by swaging.

Each of the plurality of electromagnetic steel sheets of the stator core 31 is punched into a predetermined shape.

At least one winding 32 is wound around each of the teeth 312. The winding 32 is, for example, a magnet wire.

### <Rotor 2>

The rotor 2 will be described specifically.

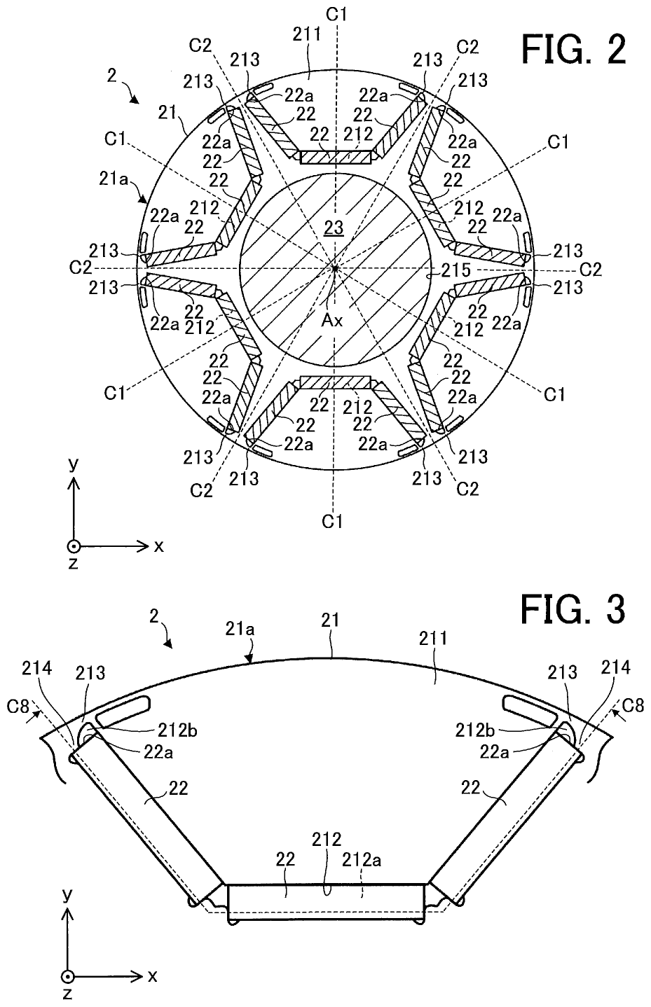

FIG. 2 is a cross-sectional view schematically illustrating a structure of the rotor 2. The electromagnetic steel sheet illustrated in FIG. 2 is a first electromagnetic steel sheet 211.

The rotor 2 includes the rotor core 21, at least one permanent magnet 22 disposed inside the rotor core 21, and a shaft 23 attached to the rotor core 21. In this embodiment, the rotor 2 is an interior permanent magnet rotor.

In the example illustrated in FIG. 2, each magnetic pole center is represented by a magnetic pole center line C1, and each inter-pole part is represented by an inter-pole line C2. That is, each magnetic pole center line C1 passes through a magnetic pole center (i.e., a center of each magnetic pole part) of the rotor 2, and each inter-pole line C2 passes through the inter-pole part of the rotor 2.

The rotor 2 is rotatably disposed inside the stator 3. The rotor 2 rotates about the axis line Ax. The axis line Ax is a rotation center of the rotor 2 and is an axis line of the shaft 23.

An air gap is present between the rotor 2 (specifically an outer peripheral surface 21a of the rotor core 21) and the stator 3. The air gap between the rotor 2 and the stator 3 is, for example, 0.3 mm to 1 mm. When a current having a frequency in synchronization with an instructed rotation speed is supplied to a coil 35 of the stator 3, a rotation magnetic field is generated in the stator 3, and thus the rotor 2 rotates.

The rotor core 21 includes two or more first electromagnetic steel sheets 211 and two or more second electromagnetic steel sheets 221. The first electromagnetic steel sheets 211 and the second electromagnetic steel sheets 221 are stacked in the axis direction. The first electromagnetic steel sheets 211 and the second electromagnetic steel sheets 221 are fixed by swaging, for example. The rotor core 21 is a cylindrical iron core.

The rotor core 21 is fixed to the shaft 23 by a fixing method such as shrink fitting or press fitting. When the rotor 2 rotates, rotation energy is transferred from the rotor core 21 and the shaft 23.

In this embodiment, the rotor 2 includes eighteen permanent magnets 22, and the number of magnetic poles of the rotor 2 is six. The three permanent magnets 22 form one magnetic pole of the rotor 2. The number of magnetic poles of the rotor 2 is not limited to six.

The shaft 23 is fixed to the rotor core 21 by a fixing method such as shrink fitting or press fitting.

Each of the permanent magnets 22 is a flat-plate magnet elongated in the axis direction, for example. Each permanent magnet 22 disposed in the rotor core 21 is magnetized in a direction perpendicular to the longitudinal direction of the permanent magnet 22 in the xy plane. That is, in the xy plane, each permanent magnet 22 is magnetized in the lateral direction (also referred to as a thickness direction) of the permanent magnet 22. Each permanent magnet 22 is a rare earth magnet containing neodymium (Nd), iron (Fe), and boron (B), for example.

At least one permanent magnet 22 disposed in the rotor core 21 has an end portion 22a (also referred to as a first end portion). In the xy plane, the end portion 22a is an end portion of the permanent magnet 22 in the longitudinal direction, and an end portion facing the outer peripheral surface 21a of the rotor core. Each permanent magnet 22 has an approximately rectangular shape when seen in the axis direction. That is, in the xy plane, the shape of each permanent magnet 22 is an approximately rectangular shape.

### <First Electromagnetic Steel Sheet 211>

FIG. 3 is an enlarged view illustrating a part of the first electromagnetic steel sheet 211.

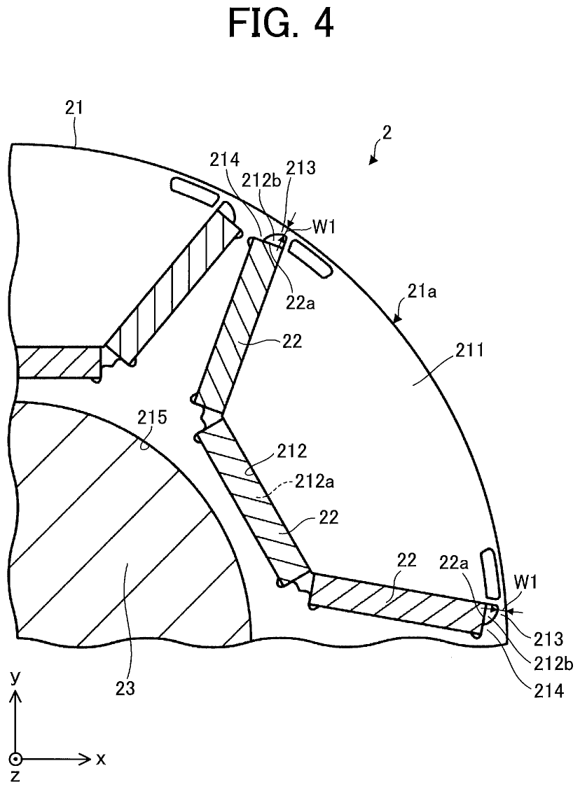

FIG. 4 is an enlarged view illustrating another part of the first electromagnetic steel sheet 211.

Each of the first electromagnetic steel sheets 211 is formed into a predetermined shape. The thickness of each first electromagnetic steel sheet 211 is, for example, 0.1 mm or more and 0.7 mm or less. In this embodiment, the thickness of each first electromagnetic steel sheet 211 is 0.35 mm. The thickness of each first electromagnetic steel sheet 211 is not limited to the range from 0.1 mm or more to 0.7 mm or less.

Each of the first electromagnetic steel sheets 211 includes at least one first magnet insertion hole 212, at least one first thin portion 213, at least one magnet locking portion 214, and a first shaft hole 215.

At least one permanent magnet 22 is disposed in each first magnet insertion hole 212. In the example illustrated in FIGS. 2 through 4, a plurality of permanent magnets 22 (three permanent magnets 22 in the example illustrated in FIGS. 2 through 4) are disposed in each first magnet insertion hole 212. The number of permanent magnets 22 in each first magnet insertion hole 212 is not limited to three.

The first magnet insertion hole 212 corresponding to one magnetic pole of the rotor 2 is preferably a single hole. In a case where the first magnet insertion hole 212 is divided into a plurality of holes, magnetic flux leakage passing through adjacent regions increases. Thus, in this embodiment, three permanent magnets 22 are disposed in one first magnet insertion hole 212 corresponding to one magnetic pole of the rotor 2. Accordingly, an increase in magnetic flux leakage can be prevented.

In the example illustrated in FIG. 2, each of the first electromagnetic steel sheets 211 includes six first magnet insertion holes 212 arranged in the circumferential direction. The number of first magnet insertion holes 212 is not limited to six.

Each of the first magnet insertion holes 212 includes at least one first magnet placement portion 212a in which at least one permanent magnet 22 is placed, and at least one first flux barrier 212b communicating with the first magnet placement portion 212a. The first magnet insertion holes 212 are through holes.

In the xy plane, a center portion of the first magnet insertion hole 212 is situated close to the axis line Ax with respect to both end portions of the first magnet insertion hole 212 in the circumferential direction of the rotor core 21. In this case, in the xy plane, each first magnet insertion hole 212 may have a U shape or a V shape.

At least one permanent magnet 22 is disposed in the first magnet placement portion 212a. In the example illustrated in FIGS. 3 and 4, three permanent magnets 22 are disposed in the first magnet placement portion 212a. Specifically, a part of each permanent magnet 22 in the axis line direction is disposed in the first magnet placement portion 212a. In this embodiment, the first magnet placement portion 212a has three regions. One permanent magnet 22 is disposed in each of the regions. Specifically, a part of one permanent magnet 22 in the axis line direction is disposed in each region.

In xy plane, the permanent magnet 22 located at the middle of the three permanent magnets 22 in each first magnet insertion hole 212 is closest to the axis line Ax among the three permanent magnets 22. In the xy plane, one permanent magnet 22 is disposed to be perpendicular to the magnetic pole center line C1, and two permanent magnets 22 at both sides of the one permanent magnet 22 are tilted with respect to the magnetic pole center line C1. Accordingly, the amount of the permanent magnets 22 at each magnetic pole part of the rotor 2 can be increased, and thus a magnetic force of the rotor 2 can be enhanced.

The first flux barriers 212b for reducing magnetic flux leakage are present at both ends of each first magnet insertion hole 212, and the first magnet placement portion 212a is present between two first flux barriers 212b.

Each of the first flux barriers 212b is space where no permanent magnet 22 is present. Each first flux barrier 212b is provided at an outer end portion of the first magnet insertion hole 212 in the radial direction of the rotor core 21. Specifically, in each first magnet insertion hole 212, two first flux barriers 212b are symmetric with respect to the magnetic pole center line C1. These first flux barriers 212b reduce magnetic flux leakage in the rotor 2, and enhance efficiency of the motor 1.

In this embodiment, each first electromagnetic steel sheet 211 includes twelve first thin portions 213. The number of the first thin portions 213 is not limited to twelve. Each first thin portion 213 is provided between the outer end portion of the first magnet insertion hole 212 in the radial direction of the rotor core 21 and the outer peripheral surface 21a of the rotor core 21. That is, each first thin portion 213 is provided between the first flux barrier 212b and the outer peripheral surface 21a of the rotor core. In other words, each first thin portion 213 is provided outside the first flux barrier 212b in the radial direction. Thus, each first thin portion 213 is a part of the first electromagnetic steel sheet 211.

Each first thin portion 213 is provided in a region adjacent to the inter-pole part of the rotor 2. Accordingly, magnetic flux leakage in the rotor 2 is reduced.

A minimum width of each first thin portion 213 in the xy plane illustrated in FIG. 4 is denoted by W1. The minimum width W1 of each first thin portion 213 is about 1 to 1.5 times as large as the thickness of each first electromagnetic steel sheet 211, for example. The minimum width W1 of each first thin portion 213 may be greater than 1.5 times the thickness of each first electromagnetic steel sheet 211. In this embodiment, the minimum width W1 of each first thin portion 213 is 0.65 mm.

In this embodiment, each first electromagnetic steel sheet 211 includes twelve magnet locking portions 214. The number of the magnet locking portions 214 is not limited to twelve. Each of the magnet locking portions 214 is adjacent to the first thin portion 213. Each magnet locking portion 214 is a part of the first electromagnetic steel sheet 211. Each magnet locking portion 214 projects into the inside of the first magnet insertion hole 212.

Each magnet locking portion 214 is in contact with the permanent magnet 22. Specifically, each magnet locking portion 214 is in contact with the end portion 22a (also referred to as a first end portion) of the permanent magnet 22. Each magnet locking portion 214 locks the permanent magnet 22 in the rotor core 21. In other words, each magnet locking portion 214 restricts movement of the permanent magnet 22 in the rotor core 21.

The shaft 23 is disposed in each first shaft hole 215.

### <Second Electromagnetic Steel Sheet 221>

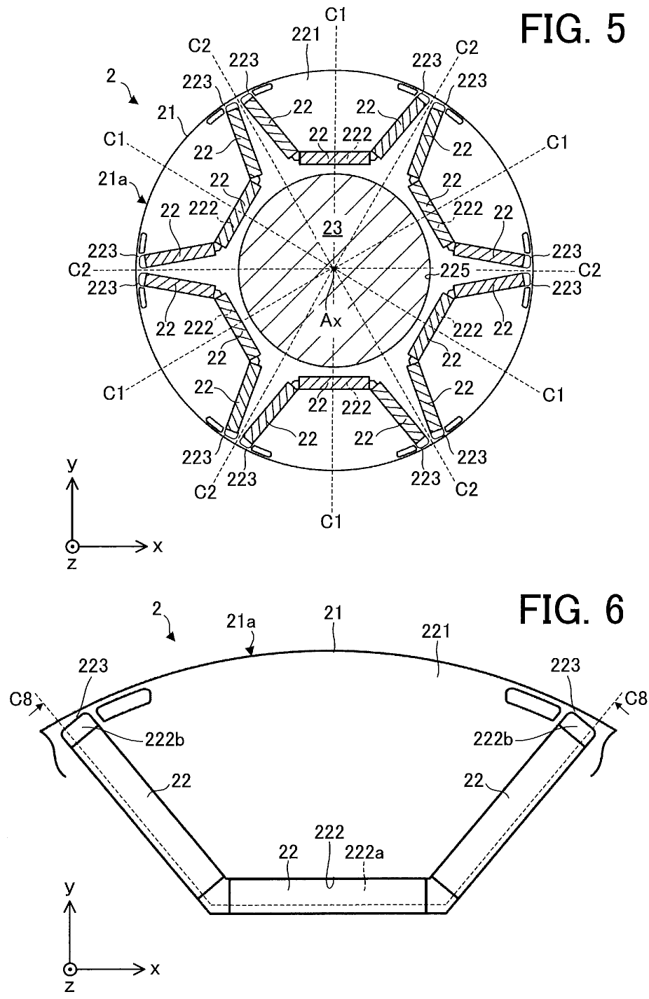

FIG. 5 is a plan view schematically illustrating a structure of the second electromagnetic steel sheet 221.

FIG. 6 is an enlarged view illustrating a part of the second electromagnetic steel sheet 221.

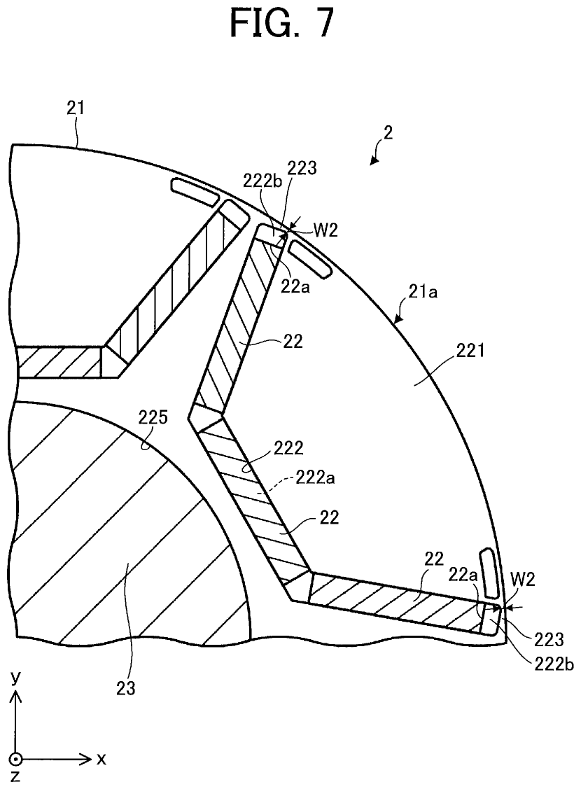

FIG. 7 is an enlarged view illustrating another part of the second electromagnetic steel sheet 221.

Each of the second electromagnetic steel sheets 221 is formed into a predetermined shape. The thickness of each second electromagnetic steel sheet 221 is, for example, 0.1 mm or more and 0.7 mm or less. In this embodiment, the thickness of each second electromagnetic steel sheet 221 is 0.35 mm. The thickness of each second electromagnetic steel sheet 221 is not limited to the range from 0.1 mm or more to 0.7 mm or less.

Each of the second electromagnetic steel sheets 221 includes at least one second magnet insertion hole 222, at least one second thin portion 223, and a second shaft hole 225.

Each second electromagnetic steel sheet 221 does not include a portion corresponding to the magnet locking portion 214 of the first electromagnetic steel sheet 211. That is, each second electromagnetic steel sheet 221 does not include a portion that is in contact with the end portion 22a of the permanent magnet 22.

Each second magnet insertion hole 222 communicates with the first magnet insertion hole 212. At least one permanent magnet 22 is disposed in each second magnet insertion hole 222. In the example illustrated in FIGS. 5 through 7, a plurality of permanent magnets 22 (three permanent magnets 22 in the example illustrated in FIGS. 5 through 7) are disposed in each second magnet insertion hole 222. The number of permanent magnets 22 in each second magnet insertion hole 222 is not limited to three.

In the example illustrated in FIG. 5, each of the second electromagnetic steel sheets 221 includes six second magnet insertion holes 222 arranged in the circumferential direction. The number of second magnet insertion holes 222 is not limited to six.

Each of the second magnet insertion holes 222 includes at least one second magnet placement portion 222a in which at least one permanent magnet 22 is placed, and at least one second flux barrier 222b communicating with the first magnet placement portion 212a. The second magnet insertion holes 222 are through holes.

In the xy plane, a center portion of the second magnet insertion hole 222 is situated close to the axis line Ax with respect to both end portions of the second magnet insertion hole 222 in the circumferential direction of the rotor core 21. In this case, in the xy plane, each second magnet insertion hole 222 may have a U shape or a V shape.

At least one permanent magnet 22 is disposed in the second magnet placement portion 222a. In the example illustrated in FIGS. 6 and 7, three permanent magnets 22 are disposed in the second magnet placement portion 222a. Specifically, a part of each permanent magnet 22 in the axis line direction is disposed in the second magnet placement portion 222a. In this embodiment, the second magnet placement portion 222a has three regions. One permanent magnet 22 is disposed in each of the regions. Specifically, a part of one permanent magnet 22 in the axis line direction is disposed in each region.

The second magnet insertion hole 222 corresponding to one magnetic pole of the rotor 2 is preferably a single hole. In a case where the second magnet insertion hole 222 is divided into a plurality of holes, magnetic flux leakage passing through adjacent regions increases. Thus, in this embodiment, the three permanent magnets 22 are disposed in one first magnet insertion hole 222 corresponding to one magnetic pole of the rotor 2. Accordingly, an increase in magnetic flux leakage can be prevented.

In xy plane, the permanent magnet 22 at the middle of the three permanent magnets 22 in each second magnet insertion hole 222 is closest to the axis line Ax among the three permanent magnets 22. In the xy plane, one permanent magnet 22 is disposed to be perpendicular to the magnetic pole center line C1, and two permanent magnets 22 at both sides of the one permanent magnet 22 are tilted with respect to the magnetic pole center line C1. Accordingly, the amount of the permanent magnets 22 at each magnetic pole part of the rotor 2 can be increased, and thus a magnetic force of the rotor 2 can be enhanced.

The second flux barriers 222b for reducing magnetic flux leakage are present at both ends of each second magnet insertion hole 222, and the second magnet placement portion 222a is present between two second flux barriers 222b.

Each of the second flux barriers 222b is space where no permanent magnet 22 is present. Each second flux barrier 222b is provided at an outer end portion of the second magnet insertion hole 222 in the radial direction of the rotor core 21. Specifically, in each second magnet insertion hole 222, two second flux barriers 222b are symmetric with respect to the magnetic pole center line C1. These second flux barriers 222b reduce magnetic flux leakage in the rotor 2, and enhance efficiency of the motor 2.

In this embodiment, each second electromagnetic steel sheet 221 has twelve second thin portions 223. The number of the second thin portions 223 is not limited to twelve. Each second thin portion 223 is provided between the outer end portion of the second magnet insertion hole 222 in the radial direction of the rotor core 21 and the outer peripheral surface 21a of the rotor core 21. That is, each second thin portion 223 is provided between the second flux barrier 222b and the outer peripheral surface 21a of the rotor core. In other words, each second thin portion 223 is provided outside the second flux barrier 222b in the radial direction. Thus, each second thin portion 223 is a part of the second electromagnetic steel sheet 221.

Each second thin portion 223 is provided in a region adjacent to the inter-pole part of the rotor 2. Accordingly, magnetic flux leakage in the rotor 2 is reduced.

A minimum width of each second thin portion 223 in the xy plane illustrated in FIG. 7 is denoted by W2. The minimum width W2 of each second thin portion 223 is about 1 to 1.5 times as large as the thickness of each second electromagnetic steel sheet 221, for example. The minimum width W2 of each second thin portion 223 may be greater than 1.5 times the thickness of each second electromagnetic steel sheet 221. In this embodiment, the minimum width W2 of each second thin portion 223 is 0.45 mm.

A relationship between the minimum width W1 of the first thin portion 213 and the minimum width W2 of the second thin portion 223 satisfies W1>W2. That is, the minimum width W2 of the second thin portion 223 is smaller than the minimum width W1 of the first thin portion 213.

Each second shaft hole 225 communicates with the first shaft hole 215. The shaft 23 is disposed in each second shaft hole 225.

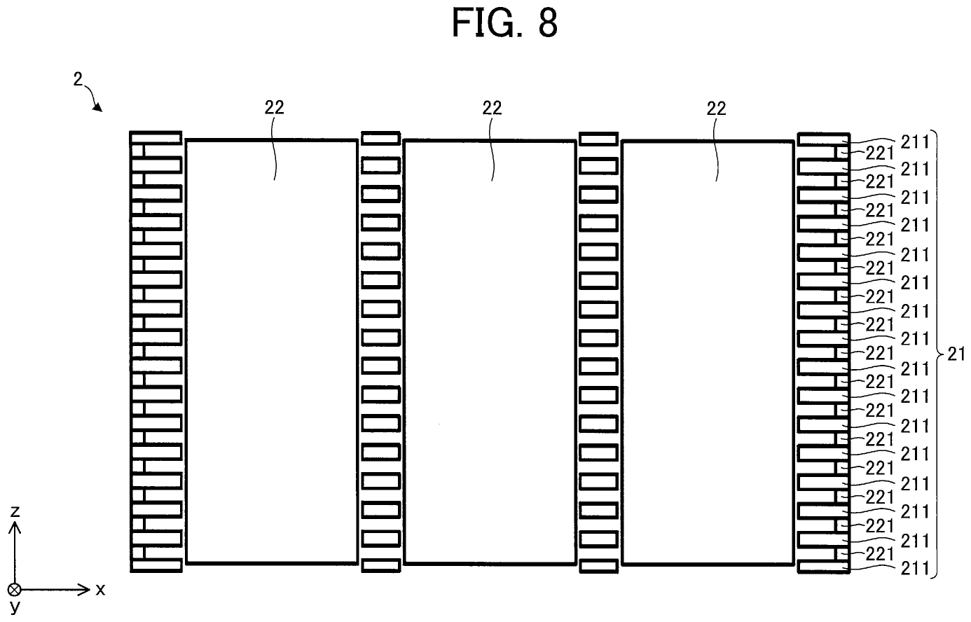

FIG. 8 is a cross-sectional view taken along line C8-C8 in FIGS. 3 and 6.

In this embodiment, the plurality of first electromagnetic steel sheets 211 are intermittently stacked, and the plurality of second electromagnetic steel sheets 221 are intermittently stacked. For example, it is sufficient that one or more first electromagnetic steel sheets 211 and one or more second electromagnetic steel sheets 221 are alternately stacked. In the example illustrated in FIG. 8, the first electromagnetic steel sheets 211 and the second electromagnetic steel sheets 221 are alternately stacked one by one.

In the rotor core 2 of the motor 1, a center portion of the first magnet insertion hole 212 is situated close to the axis line Ax with respect to both end portions of the first magnet insertion hole 212 in the circumferential direction of the rotor core 21.

A center portion of the second magnet insertion hole 222 is situated close to the axis line Ax with respect to both end portions of the second magnet insertion hole 222 in the circumferential direction of the rotor core 21. Three permanent magnets 22 are disposed in a pair of the first magnet insertion hole 212 and the second magnet insertion hole 222 that communicate with each other. That is, the three permanent magnets 22 are disposed in the pair of the first magnet insertion hole 212 and the second magnet insertion hole 222 and form an approximately U shape in the xy plane. Thus, the amount of magnets at each magnetic pole part of the rotor 2 can be increased, as compared to a rotor including a plurality of permanent magnets arranged straight in the xy plane, for example. Consequently, output density of the motor 1 can be enhanced.

However, the magnitude of a centrifugal force generated in a rotor during rotation of the rotor is generally proportional to the mass. Thus, to increase the strength of the rotor core, the width of a thin portion formed between an outer peripheral surface of the rotor core and a magnet insertion hole is preferably large. However, as the width of the thin portion increases, magnetic flux from a permanent magnet more easily passes through the thin portion, and thus magnetic flux leakage increases. Thus, the width of the thin portion is preferably designed in consideration of variations of the strength of the rotor core and reduction of magnetic flux leakage.

In this embodiment, each first electromagnetic steel sheet 211 includes at least one magnet locking portion 214 that is in contact with the end portion 22a of the permanent magnet 22. Each second electromagnetic steel sheet 221 does not include a portion that is in contact with the end portion 22a of the permanent magnet 22. Thus, the minimum width W2 of the second thin portion 223 is smaller than the minimum width W1 of the first thin portion 213.

Accordingly, the length of the second thin portion 223 in the circumferential direction can be made larger than the length of the first thin portion 213 in the circumferential direction. Consequently, the radius of the inner edge of the second thin portion 223 can be made larger than the radius of the inner edge of the first thin portion 213. Thus, stress generated in the second thin portion 223 can be reduced in each second electromagnetic steel sheet 221.

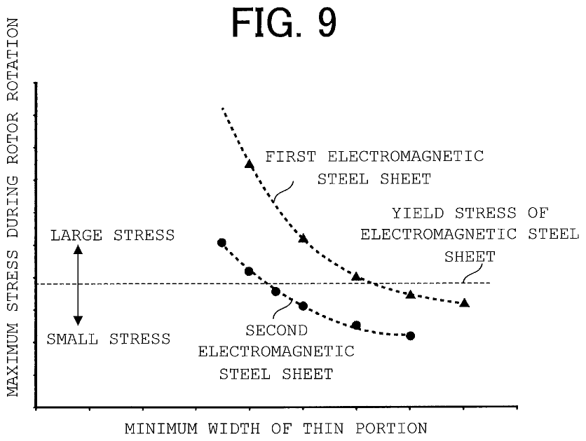

FIG. 9 is a graph showing a relationship between a minimum width of a thin portion of an electromagnetic steel sheet in the radial direction and a maximum stress generated in the thin portion during rotation of the rotor.

As shown in FIG. 9, the minimum width of the second thin portion 223 when a yield stress is generated in the second electromagnetic steel sheet 221 is smaller than the minimum width of the first thin portion 213 when a yield stress is generated in the first electromagnetic steel sheet 211. That is, with reference to a yield stress, the minimum width W2 of the second thin portion 223 can be made smaller than the minimum width W1 of the first thin portion 213.

Since the minimum width W2 of the second thin portion 223 is smaller than the minimum width W1 of the first thin portion 213, magnetic flux leakage occurring in the second electromagnetic steel sheets 221 can be reduced, as compared to magnetic flux leakage occurring in the first electromagnetic steel sheets 211.

In general, magnetic flux from a stator core passes through a portion of a rotor having a low magnetic resistance. Thus, end portions of permanent magnets facing the outer peripheral surface of a stator core are susceptible to demagnetization. When permanent magnets of the rotor are demagnetized, efficiency and output of the motor decrease. In addition, when the permanent magnets of the rotor are demagnetized, a voltage generated in the motor changes, and controllability of the motor degrades.

In view of this, in this embodiment, each second electromagnetic steel sheet 221 does not include a portion that is in contact with the end portion 22a of the permanent magnet 22. Thus, magnetic flux from the stator core passing through the second thin portion 223 having a low magnetic resistance decreases, and thus demagnetization of the permanent magnets 22 in the second electromagnetic steel sheets 221 can be suppressed.

In this embodiment, the rotor core 21 includes two or more first electromagnetic steel sheets 211 and two or more second electromagnetic steel sheets 221. Thus, strength of the rotor 2 to a centrifugal force can be enhanced in the first electromagnetic steel sheets 211 having the magnet locking portions 214, and demagnetization of the permanent magnets 22 can be suppressed in the second electromagnetic steel sheets 221 having no portions corresponding to the magnet locking portions 214. Accordingly, even in the case of increasing the number of permanent magnets 22 of the rotor 2, it is possible to improve magnetic flux leakage and demagnetization of the permanent magnets 22 while maintaining strength of the rotor 2. As a result, efficiency and output of the motor 1 can be enhanced.

In addition, in a case where one or more first electromagnetic steel sheets 211 and one or more second electromagnetic steel sheets 221 are alternately stacked, the advantages described above can be effectively obtained. Specifically, in the case where one or more first electromagnetic steel sheets 211 and one or more second electromagnetic steel sheets 221 are alternately stacked, strength of the rotor 2 to a centrifugal force can be effectively enhanced in the first electromagnetic steel sheets 211 having the magnet locking portions 214, and demagnetization of the permanent magnets 22 can be more effectively suppressed in the second electromagnetic steel sheets 221 having no portions corresponding to the magnet locking portions 214.

In a fabrication process of the second electromagnetic steel sheets 221, it is sufficient to replace a blade used in a fabrication process of the first electromagnetic steel sheets 211 by a blade for the second electromagnetic steel sheets 221. For example, in the fabrication process of the second electromagnetic steel sheets 221, it is sufficient to use a blade capable of forming the shape of the second flux barriers 222b by press work. Thus, the first electromagnetic steel sheets 211 and the second electromagnetic steel sheets 221 can be easily fabricated and stacked.

### First Variation

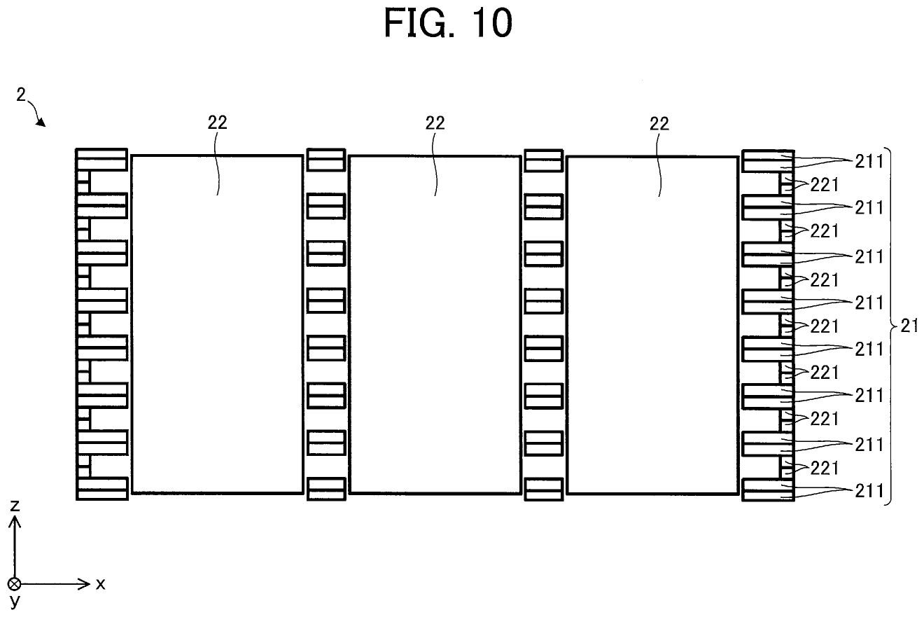

FIG. 10 is a cross-sectional view illustrating another example of the rotor core 21. The position of the cross section in FIG. 10 corresponds to the position of the cross section taken along line C8-C8 in FIG. 3.

In a first variation, two or more first electromagnetic steel sheets 211 and two or more second electromagnetic steel sheets 221 are arranged at regular intervals in the axis line direction. In other words, in the first variation, the rotor core 21 includes a plurality of first cores and a plurality of second cores. Each of the first cores is constituted by two or more first electromagnetic steel sheets 211. Each of the second cores is constituted by two or more second electromagnetic steel sheets 221. That is, in the first variation, the first cores and the second cores are arranged at regular intervals in the axis line direction. In this case, the first electromagnetic steel sheets 211 and the second electromagnetic steel sheets 221 are preferably symmetric with respect to the center of the rotor core 21 in the axis line direction.

The rotor core 21 illustrated in FIG. 10 is applicable to the rotor 2, instead of the rotor core 21 illustrated in FIG. 1. Thus, the rotor core 21 illustrated in FIG. 10 has the advantages described in this embodiment.

In addition, as illustrated in FIG. 10, in the case where two or more first electromagnetic steel sheets 211 and two or more second electromagnetic steel sheets 221 are arranged at regular intervals in the axis line direction, weight balance of the rotor core 21 in the axis line direction can be enhanced. In addition, the magnet locking portions 214 of the first electromagnetic steel sheets 211 serve as guides in inserting the permanent magnets 22 into the rotor core 21, and thus, the rotor 2 can be easily assembled. Furthermore, even in a case where the permanent magnets 22 are partially demagnetized, unbalance of demagnetization of the permanent magnets 22 in the axis line direction can be improved.

Moreover, in the case where the first electromagnetic steel sheets 211 and the second electromagnetic steel sheets 221 are symmetrically arranged with respect to the center of the rotor core 21 in the axis line direction, weight balance of the rotor core 21 in the axis line direction can be further enhanced.

### Second Variation

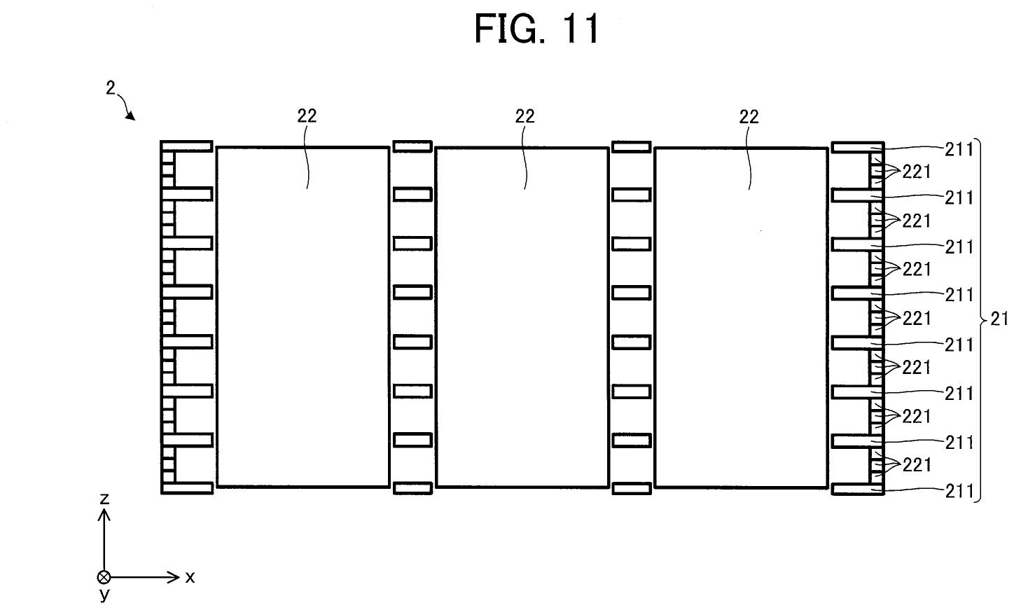

FIG. 11 is a cross-sectional view illustrating yet another example of the rotor core 21. The position of the cross section in FIG. 11 corresponds to the position of the cross section taken along line C8-C8 in FIG. 3.

In the second variation, the first electromagnetic steel sheets 211 and the second electromagnetic steel sheets 221 are arranged at regular intervals in the axis line direction. In other words, in the second variation, the rotor core 21 includes a plurality of first cores and a plurality of second cores. Each of the first cores is constituted by one or more first electromagnetic steel sheets 211. Each of the second cores is constituted by two or more second electromagnetic steel sheets 221. That is, in the second variation, the first cores and the second cores are arranged at regular intervals in the axis line direction. In this case, the first electromagnetic steel sheets 211 and the second electromagnetic steel sheets 221 are preferably symmetric with respect to the center of the rotor core 21 in the axis line direction.

In the second variation, N1<N2 is satisfied, where N1 is the number of first electromagnetic steel sheets in the rotor core 21, and N2 is the number of second electromagnetic steel sheets in the rotor core 21. In addition, the number of first electromagnetic steel sheets 211 constituting each first core is smaller than the number of second electromagnetic steel sheets 221 constituting each second core.

The rotor core 21 illustrated in FIG. 11 is applicable to the rotor 2, instead of the rotor core 21 illustrated in FIG. 1. Thus, the rotor core 21 illustrated in FIG. 11 has the advantages described in this embodiment.

Further, in a case where the rotor 2 satisfies N1<N2, it is possible to effectively improve reduce magnetic flux leakage and demagnetization of the permanent magnets 22 while maintaining sufficient strength of the rotor 2. As a result, efficiency and output of the motor 1 can be enhanced.

### Third Variation

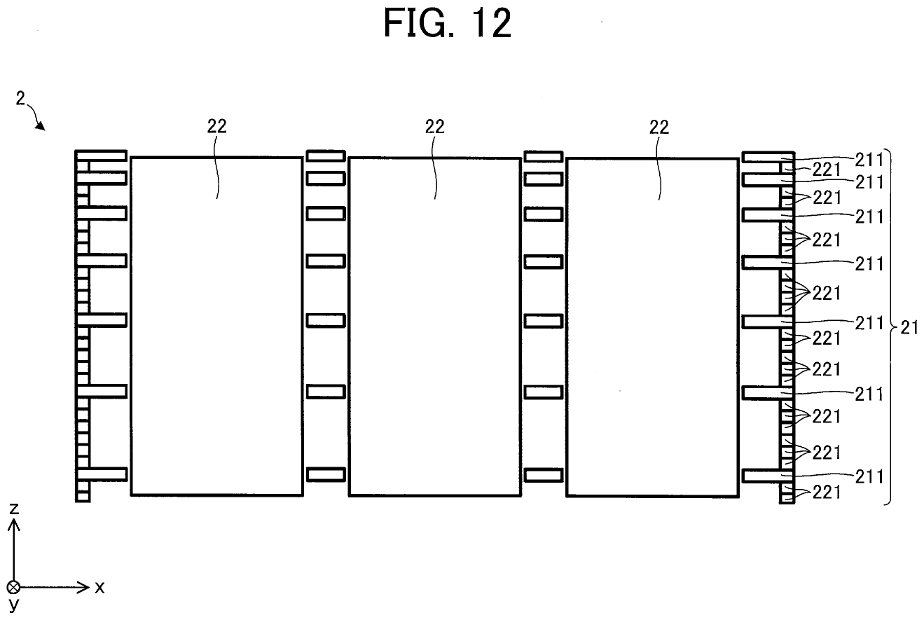

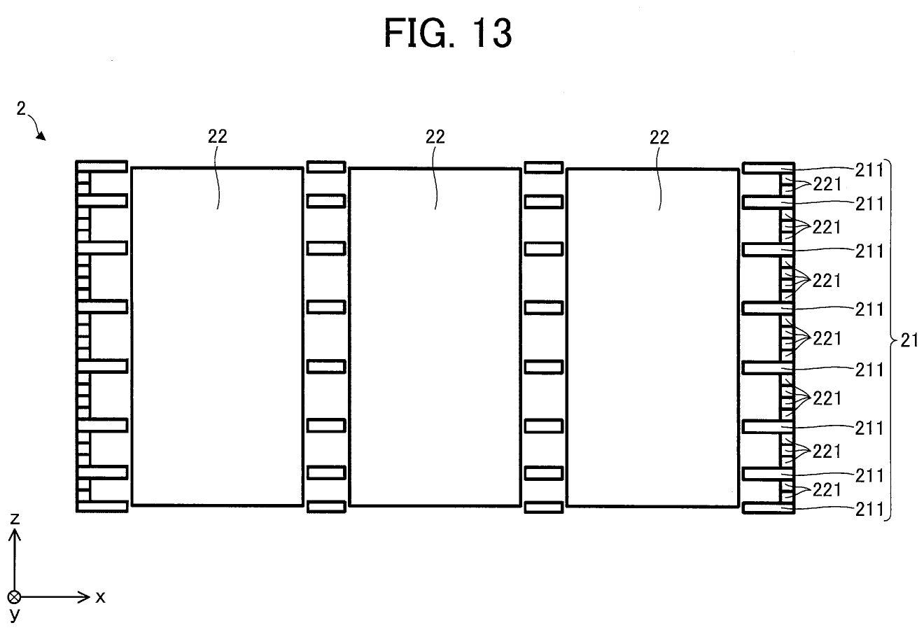

FIGS. 12 and 13 are cross-sectional views illustrating yet another example of the rotor core 21. The positions of the cross sections in FIGS. 12 and 13 correspond to the position of the cross section taken along line C8-C8 in FIG. 3.

In the third variation, the first electromagnetic steel sheets 211 and the second electromagnetic steel sheets 221 are arranged at irregular intervals in the axis line direction. In other words, in the third variation, the rotor core 21 includes a plurality of first cores and a plurality of second cores. Each of the first cores is constituted by one or more first electromagnetic steel sheets 211. Each of the second cores is constituted by one or more second electromagnetic steel sheets 221.

In this case, N1<N2 is satisfied, where N1 is the number of first electromagnetic steel sheets in the rotor core 21, and N2 is the number of second electromagnetic steel sheets in the rotor core 21. In addition, the number of first electromagnetic steel sheets 211 constituting each first core is smaller than the number of second electromagnetic steel sheets 221 constituting each second core. That is, in the third variation, the first cores and the second cores are arranged at irregular intervals in the axis line direction. In this case, the first electromagnetic steel sheets 211 and the second electromagnetic steel sheets 221 are preferably disposed symmetrically with respect to the center of the rotor core 21 in the axis line direction.

In the example illustrated in FIG. 13, the proportion of the second electromagnetic steel sheets 221 in the rotor core 21 becomes larger than the proportion of the first electromagnetic steel sheets 211 in the rotor core 21, toward the center of the rotor core 21 in the axis line direction. In other words, the density of the second electromagnetic steel sheets 221 in the rotor core 21 becomes larger than the density of the first electromagnetic steel sheets 211 in the rotor core 21, toward the center of the rotor core 21 in the axis line direction. In this case, the distance between the first electromagnetic steel sheets 211 increases toward the center of the rotor core 21 in the axis line direction.

The rotor core 21 illustrated in FIG. 12 or 13 is applicable to the rotor 2, instead of the rotor core 21 illustrated in FIG. 1. Thus, the rotor core 21 illustrated in FIG. 12 or 13 has the advantages described in this embodiment.

In addition, as illustrated in FIG. 13, the proportion of the second electromagnetic steel sheets 221 preferably becomes larger than the proportion of the first electromagnetic steel sheets 211, toward the center of the rotor core 21 in the axis line direction. Accordingly, magnetic flux leakage and demagnetization of the permanent magnets 22 can be effectively improved.

Furthermore, in a case where the first electromagnetic steel sheets 211 and the second electromagnetic steel sheets 221 are disposed symmetrically with respect to the center of the rotor core 21 in the axis line direction, weight balance of the rotor core 21 in the axis line direction can be further enhanced. In this case, even in a case where each permanent magnet 22 is partially demagnetized, unbalance of demagnetization of the permanent magnet 22 in the axis line direction can be improved.

Further, in a case where the rotor 2 satisfies N1<N2, it is possible to effectively reduce magnetic flux leakage and demagnetization of the permanent magnets 22 while maintaining sufficient strength of the rotor 2. As a result, efficiency and output of the motor 1 can be enhanced.

### Fourth Variation

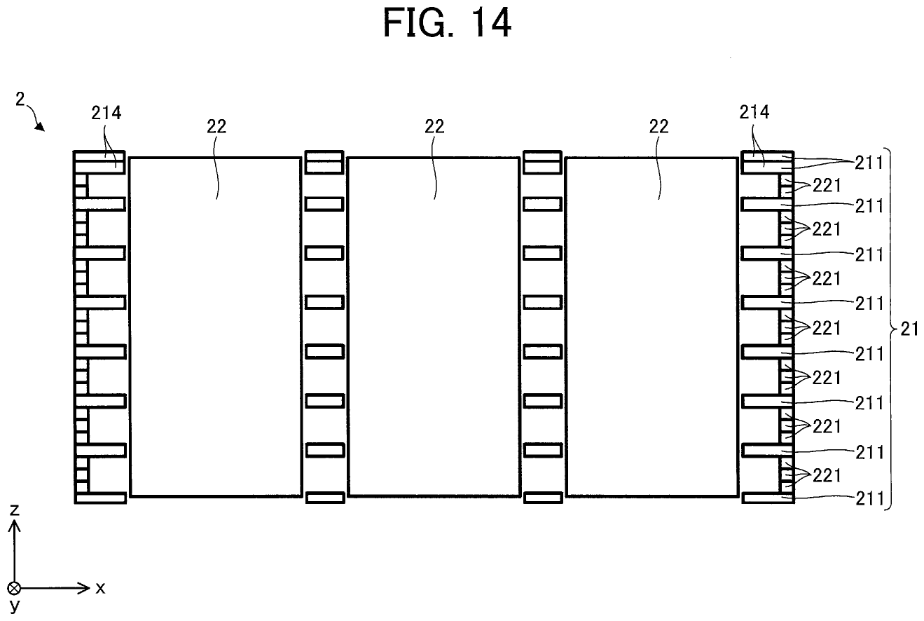

FIG. 14 is a cross-sectional view illustrating yet another example of the rotor core 21. The position of the cross section in FIG. 14 corresponds to the position of the cross section taken along line C8-C8 in FIG. 3.

In a fourth variation, one end portion of the rotor core 21 in the axis line direction is constituted by two or more first electromagnetic steel sheets 211.

The rotor core 21 illustrated in FIG. 14 is applicable to the rotor 2, instead of the rotor core 21 illustrated in FIG. 1. Thus, the rotor core 21 illustrated in FIG. 14 has the advantages described in this embodiment.

In addition, in the fourth variation, the magnet locking portions 214 of the first electromagnetic steel sheets 211 serve as guides in inserting the permanent magnets 22 in the rotor core 21, and thus, productivity of the rotor 2 can be enhanced. Further, it is possible to prevent adjacent ones of the permanent magnets 22 from contacting each other in inserting the permanent magnets 22 in the rotor core 21, and thus damage of the permanent magnets 22 can be prevented.

Moreover, in the case of forming the first electromagnetic steel sheets 211 by punching, shear drop is formed in each magnet locking portion 214. This shear drop is preferably located downstream of each magnet locking portion 214 in the insertion direction of the permanent magnets 22 in a fabrication process of the rotor 2. The insertion direction of the permanent magnets 22 is −z direction in FIG. 14. Accordingly, each permanent magnet 22 can be easily inserted in the rotor core 21.

In addition, in the case where one end portion of the rotor core 21 in the axis line direction is constituted by two or more first electromagnetic steel sheets 211, strength of the magnet locking portions 214 in the axis line direction is enhanced. As a result, deformation of the magnet locking portions 214 can be prevented in inserting the permanent magnets 22 in the rotor core 21.

Moreover, even in a case where each permanent magnet 22 comes into contact with the first electromagnetic steel sheet 211 disposed at one end portion of the rotor core 21 in inserting the permanent magnet 22 in the rotor core 21, deformation of first electromagnetic steel sheets 211 is less likely to occur.

Fifth Variation

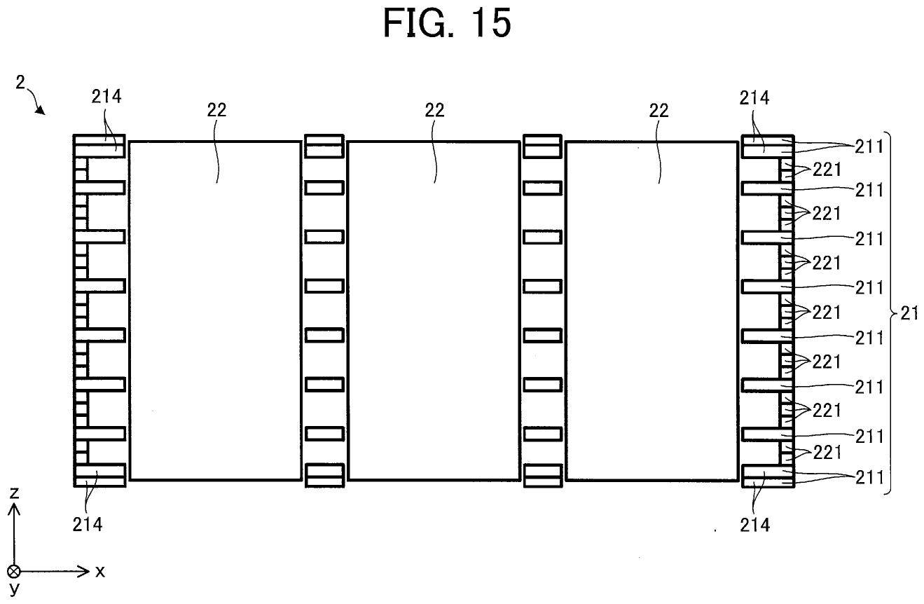

FIG. 15 is a cross-sectional view illustrating yet another example of the rotor core 21. The position of the cross section in FIG. 15 corresponds to the position of the cross section taken along line C8-C8 in FIG. 3.

In a fifth variation, each end portion of the rotor core 21 in the axis line direction is constituted by two or more first electromagnetic steel sheets 211.

The rotor core 21 illustrated in FIG. 15 is applicable to the rotor 2, instead of the rotor core 21 illustrated in FIG. 1. Thus, the rotor core 21 illustrated in FIG. 15 has the advantages described in this embodiment.

In addition, the fifth variation has the advantages described in the fourth variation.

Further, in the case where each end portion of the rotor core 21 in the axis line direction is constituted by two or more first electromagnetic steel sheets 211, the magnet locking portions 214 of the first electromagnetic steel sheets 211 serve as guides in inserting the permanent magnet 22 in the rotor core 21. Thus, the permanent magnets 22 can be easily inserted in the rotor core 21 from above or below the rotor core 21. As a result, productivity of the rotor 2 can be enhanced.

Sixth Variation

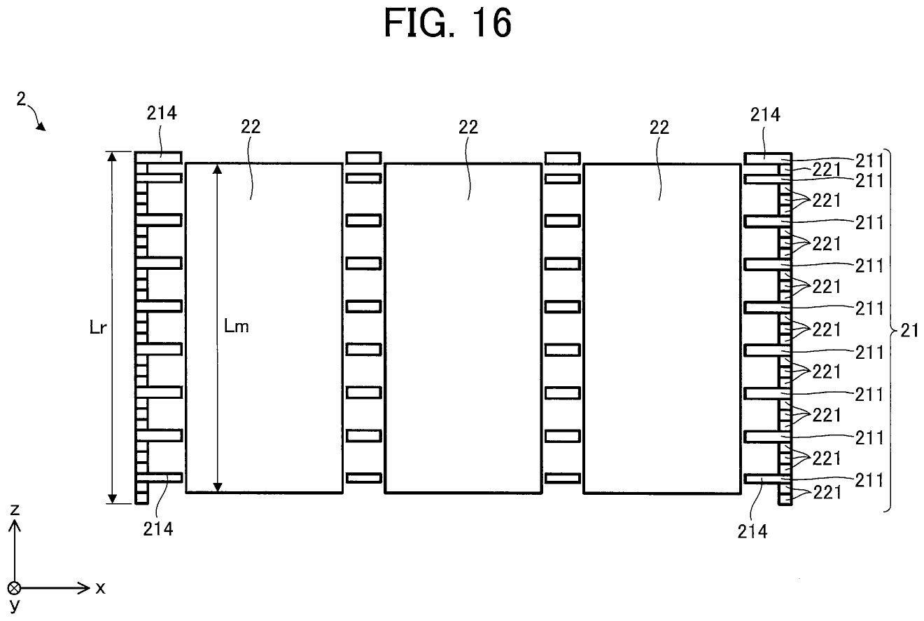

FIG. 16 is a cross-sectional view illustrating yet another example of the rotor core 21. The position of the cross section in FIG. 16 corresponds to the position of the cross section taken along line C8-C8 in FIG. 3.

In a sixth variation, the rotor 2 satisfies L1>Ld. In this case, L1 is a minimum distance from one end of the first electromagnetic steel sheet 211 in the axis line direction to an end portion of the rotor core 21 in the axis line direction. The length Ld is a difference between the length Lr and the length Lm. The length Lr is a length of the rotor core 21 in the axis line direction. The length Lm is a length of each permanent magnet 22 in the axis line direction. That is, in the sixth variation, each magnet locking portion 214 of at least one first electromagnetic steel sheet 211 is located closer to the center of the rotor core 21 in the axis line direction than both end portions of the permanent magnet 22. Thus, at least one permanent magnet 22 is restricted by at least one magnet locking portion 214.

The rotor core 21 illustrated in FIG. 16 is applicable to the rotor 2, instead of the rotor core 21 illustrated in FIG. 1. Thus, the rotor core 21 illustrated in FIG. 16 has the advantages described in this embodiment.

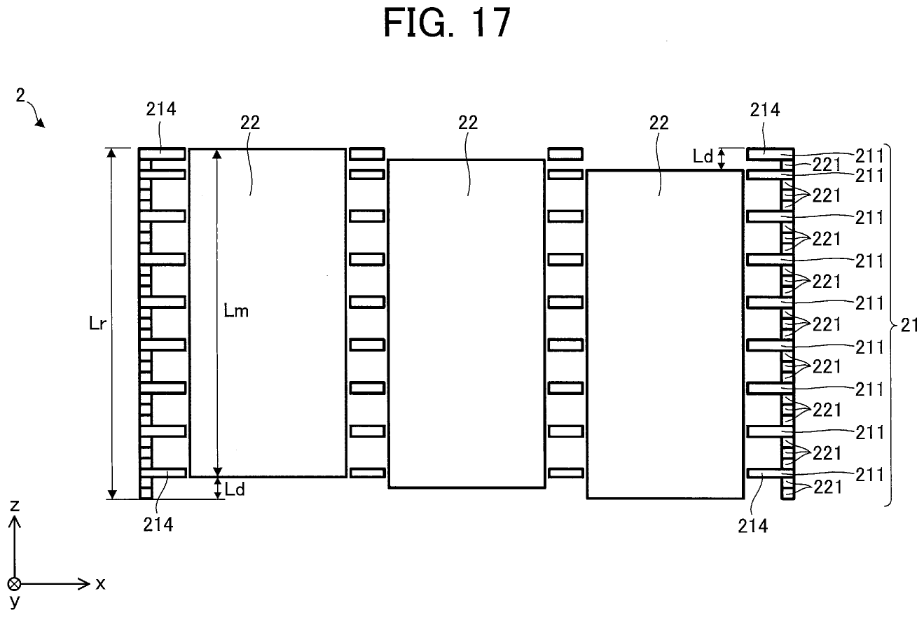

FIG. 17 is a diagram illustrating an example where the permanent magnets 22 in the rotor core 21 illustrated in FIG. 16 are shifted in the axis line direction.

As illustrated in FIG. 17, in the sixth variation, even in the case where the permanent magnets 22 are shifted to one side in the axis line direction, movement of the permanent magnets 22 in the radial direction is restricted by the magnet locking portion 214 of the first electromagnetic steel sheet 211 disposed at one end of the rotor core 21 in the axis line direction.

Seventh Variation

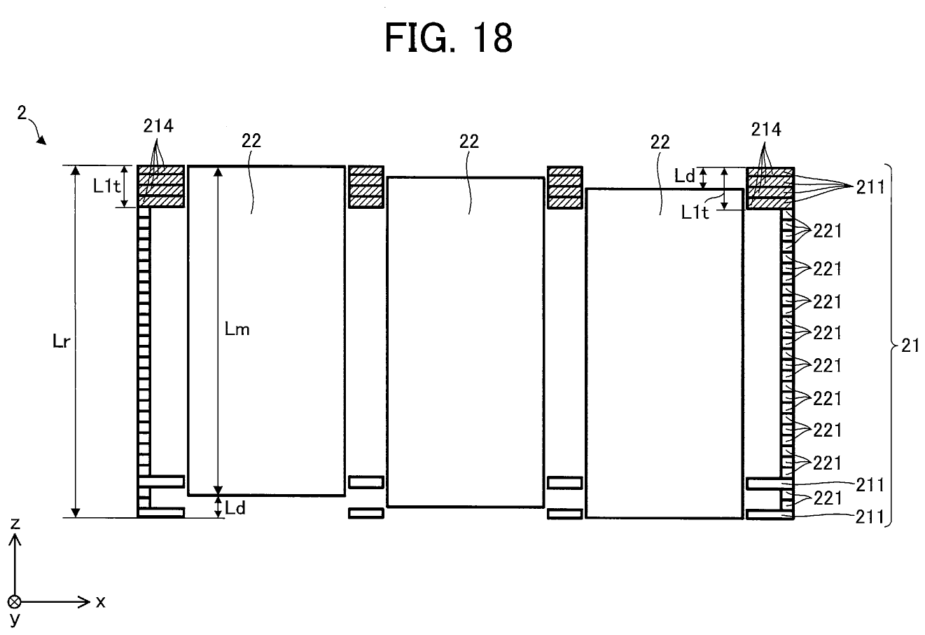

FIG. 18 is a cross-sectional view illustrating yet another example of the rotor core 21. The position of the cross section in FIG. 18 corresponds to the position of the cross section taken along line C8-C8 in FIG. 3.

In a seventh variation, a first end portion of the rotor core 21 in the axis line direction is constituted by two or more first electromagnetic steel sheets 211. In FIG. 18, the first end portion of the rotor core 21 in the axis line direction is hatched. In this case, the rotor 2 satisfies Lr>Lm and L1t>Ld. The width L1t is a width in the axis line direction of two or more first electromagnetic steel sheets 211 disposed at the first end portion of the rotor core 21. The length Lr is a length of the rotor core 21 in the axis line direction. The length Lm is a length of each permanent magnet 22 in the axis line direction. The length Ld is a difference between the length Lr and the length Lm.

The rotor core 21 illustrated in FIG. 18 is applicable to the rotor 2, instead of the rotor core 21 illustrated in FIG. 1. Thus, the rotor core 21 illustrated in FIG. 18 has the advantages described in this embodiment.

In addition, in the seventh variation, the rotor 2 satisfies L1t>Ld. In this case, each magnet locking portion 214 of the first electromagnetic steel sheets 211 serves as a guide in at least the first end portion of the rotor core 21 in the axis line direction in inserting the permanent magnets 22 in the rotor core 21. Thus, each magnet locking portion 214 of the first electromagnetic steel sheets 211 serves as a guide at the at least one end of the rotor core 21 in the axis line direction in inserting the permanent magnets 22 in the rotor core 21. Thus, each permanent magnet 22 can be easily inserted in the rotor core 21 from above or below the rotor core 21. As a result, productivity of the rotor 2 can be enhanced.

### Eighth Variation

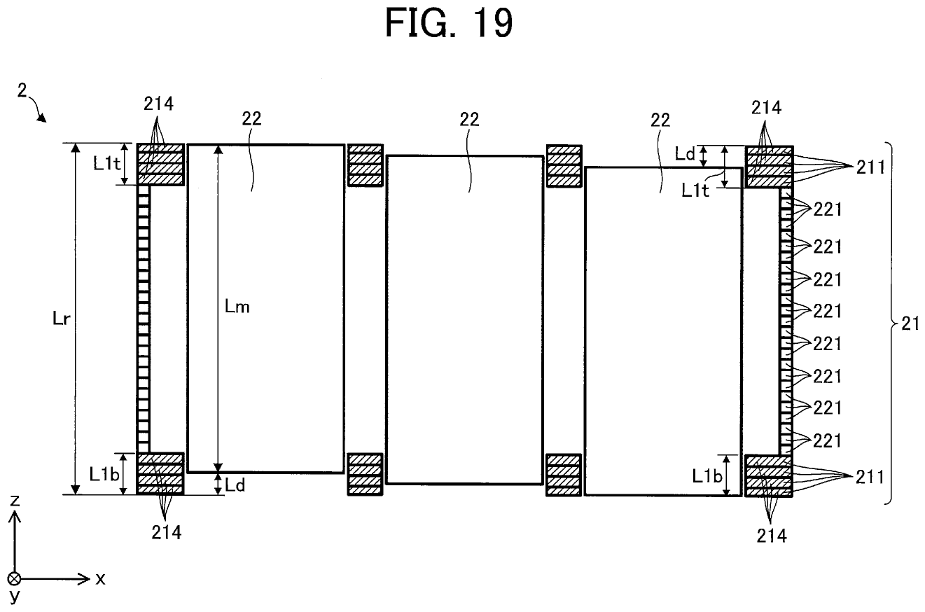

FIG. 19 is a cross-sectional view illustrating yet another example of the rotor core 21. The position of the cross section in FIG. 19 corresponds to the position of the cross section taken along line C8-C8 in FIG. 3.

In an eighth variation, the first end portion of the rotor core 21 in the axis line direction is constituted by two or more first electromagnetic steel sheets 211, and a second end portion of the rotor core 21 in the axis line direction is constituted by two or more first electromagnetic steel sheets 211. In FIG. 19, the first end portion of the rotor core 21 in the axis line direction is an area represented by hatching. Similarly, in FIG. 19, the second end portion of the rotor core 21 in the axis line direction is an area represented by hatching. That is, the rotor core 21 includes two or more first electromagnetic steel sheets 211 disposed at the first end portion of the rotor core 21 in the axis line direction, and also includes two or more first electromagnetic steel sheets 211 disposed at the second end portion of the rotor core 21 in the axis line direction.

The second end portion of the rotor core 21 is located opposite to the first end portion of the rotor core 21 in the axis line direction. The two or more first electromagnetic steel sheets 211 disposed at the first end portion of the rotor core 21 will also be referred to as “first cores,” and the two or more first electromagnetic steel sheets 211 disposed at the second end portion of the rotor core 21 will also be referred to as “second cores.” The two or more second electromagnetic steel sheets 221 are disposed between the first cores and the second cores.

In this case, the rotor 2 satisfies Lr>Lm, L1t>Ld, and L1b>Ld. The width L1t is a width, in the axis line direction, of two or more first electromagnetic steel sheets 211 disposed at the first end portion of the rotor core 21. The width L1b is a width, in the axis line direction, of two or more first electromagnetic steel sheets 211 disposed at the second end portion of the rotor core 21. The length Lr is a length of the rotor core 21 in the axis line direction. The length Lm is a length of each permanent magnet 22 in the axis line direction. The length Ld is a difference between the length Lr and the length Lm.

The rotor core 21 illustrated in FIG. 19 is applicable to the rotor 2, instead of the rotor core 21 illustrated in FIG. 1. Thus, the rotor core 21 illustrated in FIG. 19 has the advantages described in this embodiment.

In addition, the eighth variation has the advantages described in the seventh variation.

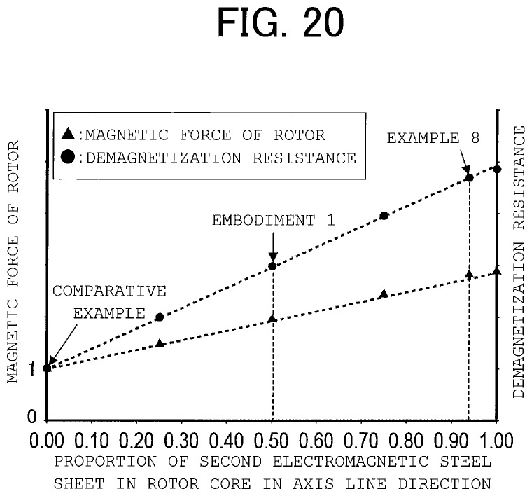

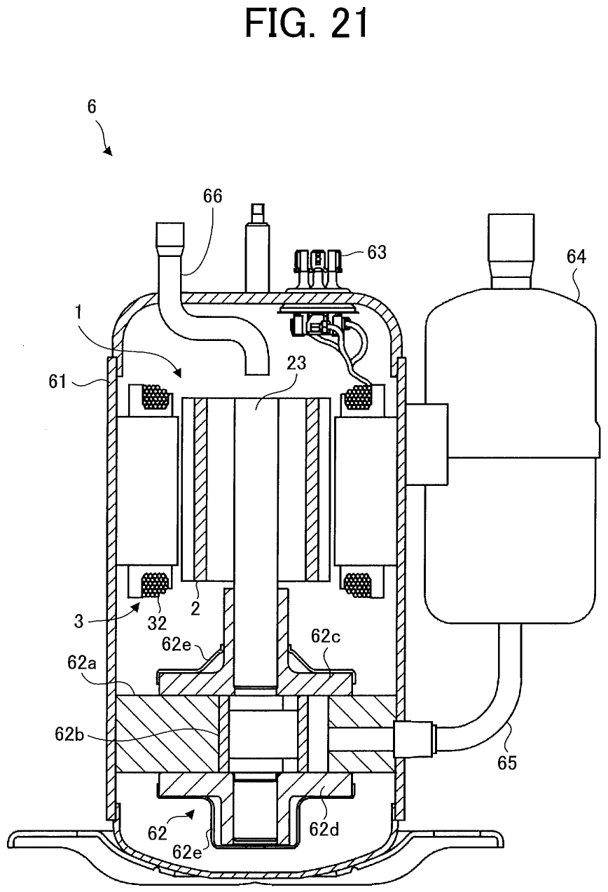

FIG. 20 is a graph showing a magnetic force of the rotor 2 and a magnitude of demagnetization resistance with reference to a comparative example. The comparative example employs a rotor in which a rotor core is constituted only by one or more first electromagnetic steel sheets 211. That is, the rotor core according to the comparative example includes no second electromagnetic steel sheets 221. The horizontal axis in FIG. 20 represents a proportion of second electromagnetic steel sheets 221 in the rotor core 21 in the axis line direction. Specifically, the horizontal axis in FIG. 20 represents a proportion of the widths of the second electromagnetic steel sheets 221 in the axis line direction in the width of the rotor core 21 in the axis line direction.

In the rotor 2 according to the first embodiment, a proportion of the sum of the widths of the second electromagnetic steel sheets 221 in the axis line direction in the width of the rotor core 21 in the axis line direction is 0.50. In the rotor 2 according to the eighth variation, a proportion of the sum of the widths of the second electromagnetic steel sheets 221 in the axis line direction in the width of the rotor core 21 in the axis line direction is 0.94.

As shown in FIG. 20, as the proportion of the sum of the widths of the second electromagnetic steel sheets 221 in the axis line direction in the width of the rotor core 21 in the axis line direction increases, demagnetization resistance of the rotor 2 is improved. Thus, as shown in FIG. 20, the proportion of the sum of the widths of the second electromagnetic steel sheets 221 in the axis line direction in the width of the rotor core 21 in the axis line direction is preferably larger than 0.10 and smaller than 1.00. The proportion of the sum of the widths of the second electromagnetic steel sheets 221 in the axis line direction in the width of the rotor core 21 in the axis line direction is more preferably 0.50 or more and 0.94 or less.

### Second Embodiment

A compressor 6 according to a second embodiment will be described.

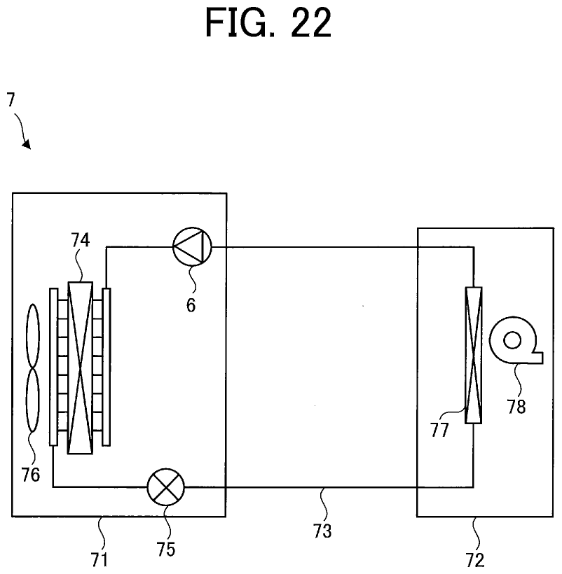

FIG. 21 is a cross-sectional view schematically illustrating a structure of the compressor 6 according to the second embodiment.

The compressor 6 includes a motor 1 as an electric element, a shell 61 (also referred to as a closed container) as a housing, and a compression mechanism 62 as a compression element (also referred to as a compression device). In this embodiment, the compressor 6 is a rotary compressor. The compressor 6 is not limited to the rotary compressor.

The compressor 6 is used for a refrigeration cycle in an air conditioner, for example.

The motor 1 in the compressor 6 is the motor 1 described in the first embodiment. The motor 1 drives the compression mechanism 62.

The shell 61 covers the motor 1 and the compression mechanism 62. The shell 61 is a cylindrical container. The shell 61 is formed of, for example, a steel sheet. The shell 61 may be divided into an upper shell and a lower shell, or may be a single structure. Refrigerating machine oil for lubricating a sliding part of the compression mechanism 62 is stored in a bottom portion of the shell 61.

The compressor 6 also includes a glass terminal 63 fixed to the shell 61, an accumulator 64, a suction pipe 65, and a discharge pipe 66 for discharging a refrigerant to the outside of the compressor 6.

The compression mechanism 62 includes a cylinder 62a, a piston 62b, an upper frame 62c (also referred to as a first frame), a lower frame 62d (also referred to as a second frame), and a plurality of mufflers 62e individually attached to the upper frame 62c and the lower frame 62d. The compression mechanism 62 also includes a vane that divides a region in the cylinder 62a into a suction side and a compression side. The compression mechanism 62 is disposed inside the shell 61. The compression mechanism 62 is driven by the motor 1.

The glass terminal 63 is a terminal for supplying electric power from a power supply to the motor 1 in the compressor 6.

A coil (e.g., the winding 32 described in the first embodiment) of the motor 1 is supplied with electric power through the glass terminal 63.

A rotor 2 (specifically, one side of a shaft 23) of the motor 1 is rotatably supported by a bearing included in each of the upper frame 62c and the lower frame 62d.

The shaft 23 is inserted in the piston 62b. The shaft 23 is rotatably inserted in the upper frame 62c and the lower frame 62d. Accordingly, the shaft 23 can transfer a driving force of the motor 1 to the compression mechanism 62.

The upper frame 62c and the lower frame 62d close an end face of the cylinder 62a. The accumulator 64 supplies a refrigerant (e.g., refrigerant gas) to the cylinder 62a through the suction pipe 65.

Next, an operation of the compressor 6 will be described. A refrigerant supplied from the accumulator 64 is sucked into the cylinder 62a from the suction pipe 65 fixed to the shell 61. Rotation of the motor 1 causes the piston 62b fitted in the shaft 23 to rotate in the cylinder 62a. Accordingly, the refrigerant is compressed in the cylinder 62a.

The compressed refrigerant flows through the mufflers 62e and moves upward in the shell 61. In this manner, the compressed refrigerant is supplied to a high-pressure side of the refrigeration cycle through the discharge pipe 66.

Examples of the refrigerant of the compressor 6 include R410A, R407C, and R22. It should be noted that the refrigerant of the compressor 6 is not limited to these types of the refrigerant. As a refrigerant of the compressor 6, a refrigerant having a small global warming potential (GWP), such as refrigerants listed below, may be used.

(1) Halogenated hydrocarbon having a carbon double bond in its composition, such as hydro-fluoro-orefin (HFO)-1234yf (CF3CF═CH2). HFO-1234yf has a GWP of 4.
(2) Hydrocarbon having a carbon double bond in its composition, such as R1270 (propylene). R1270 has a GWP of 3, which is smaller than that of HFO-1234yf, but has flammability higher than that of HFO-1234yf.
(3) A mixture including halogenated hydrocarbon having a carbon double bond in its composition or hydrocarbon having a carbon double bond in its composition, and a mixture including both of the halogenated hydrocarbon and the hydrocarbon. For example, a mixture of HFO-1234yf and R32 may be used. Since HFO-1234yf described above is a low-pressure refrigerant, a pressure loss tends to increase, and performance of a refrigeration cycle (especially an evaporator) might degrade. In view of this, it is practically preferable to use a mixture including R32 or R41, which are higher-pressure refrigerants than HFO-1234yf.

The compressor 6 according to the second embodiment has the advantages described in the first embodiment.

In addition, since the compressor 6 according to the second embodiment includes the motor 1 according to the first embodiment, efficiency of the compressor 6 can be increased.

### Third Embodiment

A refrigeration air conditioning apparatus 7 serving as an air conditioner and including the compressor 6 according to the second embodiment will be described.

FIG. 22 is a diagram schematically illustrating a configuration of the refrigerating air conditioning device 7 according to the third embodiment.

The refrigeration air conditioning apparatus 7 is capable of performing cooling and heating operations, for example. A refrigerant circuit diagram illustrated in FIG. 22 is an example of a refrigerant circuit diagram of an air conditioner capable of performing a cooling operation.

The refrigeration air conditioning apparatus 7 according to the third embodiment includes an outdoor unit 71, an indoor unit 72, and a refrigerant pipe 73 connecting the outdoor unit 71 and the indoor unit 72 to each other.

The outdoor unit 71 includes a compressor 6, a condenser 74 as a heat exchanger, a throttling device 75, and an outdoor air blower 76 (also referred to as an air blower). The condenser 74 condenses a refrigerant compressed by the compressor 6. The throttling device 75 decompresses the refrigerant condensed by the condenser 74 to thereby adjust a flow rate of the refrigerant. The throttling device 75 will be also referred to as a decompression device.

The indoor unit 72 includes an evaporator 77 as a heat exchanger, and an indoor air blower 78 (also referred to as an air blower). The evaporator 77 evaporates the refrigerant decompressed by the throttling device 75 to thereby cool indoor air.

A basic operation of a cooling operation in the refrigeration air conditioning apparatus 7 will now be described as an example of operation of the refrigeration air conditioning apparatus 7. In the cooling operation, a refrigerant is compressed by the compressor 6 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 6 of the outdoor unit 71 again. When the air is sent to the condenser 74 by the outdoor air blower 76, heat moves between the refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present invention is not limited to the examples described above.

The refrigeration air conditioning apparatus 7 according to the third embodiment has the advantages described in the first and second embodiments.

In addition, since the refrigeration air conditioning apparatus 7 according to the third embodiment includes the compressor 6 according to the second embodiment, efficiency of the refrigeration air conditioning apparatus 7 can be increased.

As described above, preferred embodiments have been specifically described. However, it is obvious that those skilled in the art would take various modified variations based on the basic technical idea and teaching of the present invention.

Features of the embodiments and features of the variations described above can be combined as appropriate.

1. A rotor comprising:
a rotor core including two or more first electromagnetic steel sheets and two or more second electromagnetic steel sheets that are stacked in an axis line direction; and
at least one permanent magnet disposed in the rotor core, wherein
each of the two or more first electromagnetic steel sheets includes
a first magnet insertion hole in which the at least one permanent magnet is disposed,
a first thin portion provided between an outer end portion of the first magnet insertion hole in a radial direction of the rotor core and an outer peripheral surface of the rotor core, and
a magnet locking portion that is adjacent to the first thin portion and is in contact with an end of the at least one permanent magnet, the end of the at least one permanent magnet facing the outer peripheral surface of the rotor core,
a center portion of the first magnet insertion hole is situated close to an axis line with respect to both end portions of the first magnet insertion hole in a circumferential direction in a plane perpendicular to the axis line,
each of the two or more second electromagnetic steel sheets includes
a second magnet insertion hole in which the at least one permanent magnet is disposed, the second magnet insertion hole communicating with the first magnet insertion hole, and
a second thin portion provided between an outer end portion of the second magnet insertion hole in the radial direction and the outer peripheral surface of the rotor core,
a center portion of the second magnet insertion hole is situated close to the axis line with respect to both end portions of the second magnet insertion hole in the circumferential direction in the plane,
each of the two or more second electromagnetic steel sheets does not include a portion that is in contact with the end of the at least one permanent magnet,
W1>W2 is satisfied, where W1 is a minimum width of the first thin portion in the plane and W2 is a minimum width of the second thin portion in the plane, and
a length of the second thin portion in the circumferential direction is larger than a length of the first thin portion in the circumferential direction.

2. The rotor according to claim 1, wherein the two or more first electromagnetic steel sheets and the two or more second electromagnetic steel sheets are arranged at regular intervals in the axis line direction.

3. The rotor according to claim 1, wherein the two or more first electromagnetic steel sheets and the two or more second electromagnetic steel sheets are arranged at irregular intervals in the axis line direction.

4. The rotor according to claim 1, wherein N1<N2 is satisfied, where N1 is the number of the two or more first electromagnetic steel sheets, and N2 is the number of the two or more second electromagnetic steel sheets.

5. The rotor according to claim 1, wherein one end portion of the rotor core in the axis line direction is constituted by the two or more first electromagnetic steel sheets.

6. The rotor according to claim 1, wherein both end portions of the rotor core in the axis line direction is constituted by the two or more first electromagnetic steel sheets.

7. The rotor according to claim 1, wherein L1>Ld is satisfied, where Lr is a length of the rotor core in the axis line direction, Lm is a length of at least one permanent magnet in the axis line direction, Ld is a difference between the length Lr and the length Lm, and L1 is a minimum distance from one end of the two or more first electromagnetic steel sheets in the axis line direction to an end portion of the rotor core in the axis line direction.

8. The rotor according to claim 1, wherein
a first end portion of the rotor core in the axis line direction is constituted by the two or more first electromagnetic steel sheets, and
Lr>Lm and L1t>Ld are satisfied, where L1t is a width, in the axis line direction, of the two or more first electromagnetic steel sheets disposed at the first end portion of the rotor core, Lr is a length of the rotor core in the axis line direction, Lm is a length of at least one permanent magnet in the axis line direction, and Ld is a difference between the length Lr and the length Lm.

9. The rotor according to claim 8, wherein
the rotor core further includes the two or more first electromagnetic steel sheets disposed at a second end portion of the rotor core in the axis line direction, and
L1b>Ld is satisfied, where L1b is a width, in the axis line direction, of the two or more first electromagnetic steel sheets disposed at the second end portion of the rotor core.

10. A motor comprising:
a stator; and
the rotor according to claim 1 disposed inside the stator.

11. A compressor comprising:
a compression device; and
the motor according to claim 10 to drive the compression device.

12. An air conditioner comprising:
the compressor according to claim 11; and
a heat exchanger.
